(19) United States
(12) Patent Application Publication
(10) Pub. No.: US 2011/0006741 A1
(43) Pub. Date: Jan. 13, 2011

(54) BUILDING AND POWER STORING METHOD

(75) Inventor: Masato ANDO, Nagoya-shi (JP)

Correspondence Address: OLIFF & BERRIDGE, PLC, P.O. BOX 320850, ALEXANDRIA, VA, 22320-4850, US

(73) Assignees: TOYOTA JIDOSHA KABUSHIKI KAISHA, Toyota-shi (JP); TOYOTA HOUSING CORPORATION, Nagoya-shi (JP)

(21) Appl. No.: 12/828,531

(22) Filed: Jul. 1, 2010

(30) Foreign Application Priority Data
Jul. 9, 2009 (JP) 2009-163001

(51) Int. Cl. H02J 7/04; E04H 14/00; H02J 7/00

(52) U.S. Cl. 320/162; 52/173.1; 320/137

(57) ABSTRACT

A building includes: a plurality of secondary battery housing portions provided dispersed in a plurality of locations inside or inside and outside; and a plurality of secondary batteries, a respective one of the secondary batteries housed in a respective one of the plurality of secondary battery housing portions.

### INCORPORATION BY REFERENCE

The disclosure of Japanese Patent Application No. 2009-163001 filed on Jul. 9, 2009 including the specification, drawings and abstract is incorporated herein by reference in its entirety.

### BACKGROUND OF THE INVENTION

1. Field of the Invention

The invention relates to a building provided with a secondary battery, as well as to a power storing method of a plurality of secondary batteries arranged in a building.

2. Description of the Related Art

Japanese Patent No. 2839734 describes an invention relating to a power supply. In brief, the power supply apparatus forms a high quality power supply network for interconnecting the output of power converters of different capacities and connects a plurality of loads in various locations to the high quality power supply network. System controllers provided in the power converters send information regarding the operating status and the like of the power converters to an integrated controller. The power supply then controls the operation of each power converter based on each load of the plurality of loads that the high quality power network needs to supply power to, and information regarding the operating status of the power converters received from the system controllers and the like.

Here, the related art aims to provide flexibility in expanding a load system and the like without providing a special power supply room, with a power supply that supplies stable alternating current (AC) power to an important load system such as a computer system, and is therefore not originally intended to be applied to a building such as a house.

However, there are demands of improvements such as conforming buildings such as houses to technological trends as technologies that utilize secondary batteries, such as plug-in hybrid vehicles, electric vehicles, and fuel cell vehicles, advance.

### SUMMARY OF THE INVENTION

This invention provides a building in which power corresponding to a load can easily be drawn from various locations indoors or indoors and outdoors.

A first aspect of the invention relates to a building. This building includes a plurality of secondary battery housing portions provided dispersed in a plurality of locations inside or inside and outside, and a plurality of secondary batteries, a respective one of the secondary batteries housed in a respective one of the plurality of secondary battery housing portions.

According to this aspect, a plurality of secondary battery housing portions and secondary batteries are provided dispersed in a plurality of locations inside or inside and outside the building, so if power is needed, it can be supplied from the secondary battery nearest the location where it is needed. Therefore, it is easier to draw power stored in the secondary batteries than it is when a secondary battery housing portion and a secondary battery are arranged in only one location in a building.

A second aspect of the invention relates to a power storing method of a plurality of secondary batteries arranged in a building. This power storing method includes checking a predetermined order of priority when charging the plurality of secondary batteries, and charging starting with the secondary battery that is highest in the order of priority.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a first floor plan view of a house according to an example embodiment of the invention;

FIG. 2 is a perspective view schematically showing the house according to the example embodiment;

FIG. 3 is an enlarged sectional plan view of a secondary battery housing portion and a secondary battery shown in FIG. 1;

FIG. 4 is a front elevation of a louver and an operating panel shown in FIG. 3;

FIG. 5 is a block view of a power storage system according to the example embodiment;

FIG. 6 is a front elevation of a monitor shown in FIG. 5;

FIG. 7 is a system diagram of the power storage system according to the example embodiment; and

FIG. 8 is a flowchart illustrating control during charging of the power storage system according to this example embodiment.

### DETAILED DESCRIPTION OF EMBODIMENTS

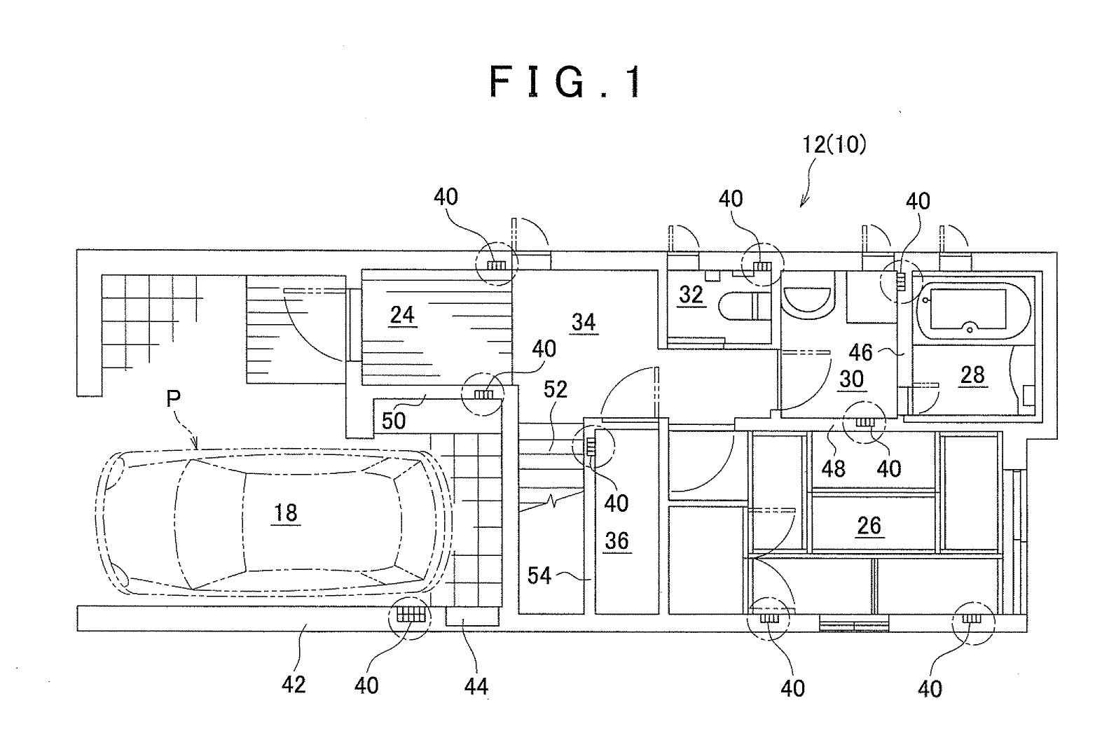

Hereinafter, an example embodiment of the building of the present invention will be described in greater detail below with reference to FIGS. 1 to 8.

FIG. 1 is a first floor plan view of a house 10 that serves as the building of the invention. As shown in the drawing, an indoor garage 18 and an entryway 24 are provided in the front of a first floor portion 12. Also, a Japanese-style room (a spare room) 26, a bathroom (i.e., a bath and shower room) 28, a washroom 30, and a separate toilet 32 are provided in the back side of the first floor portion 12. Further, a hall 34 is provided to the rear of the entryway 24, and a storage space 36 is provided between the Japanese-style room 26 and the indoor garage 18. Incidentally, the house 10 in this example embodiment is structured as a building with a steel framed construction, though the type of structure of the building is not limited to this. For example, it may also be a unit house or some other type.

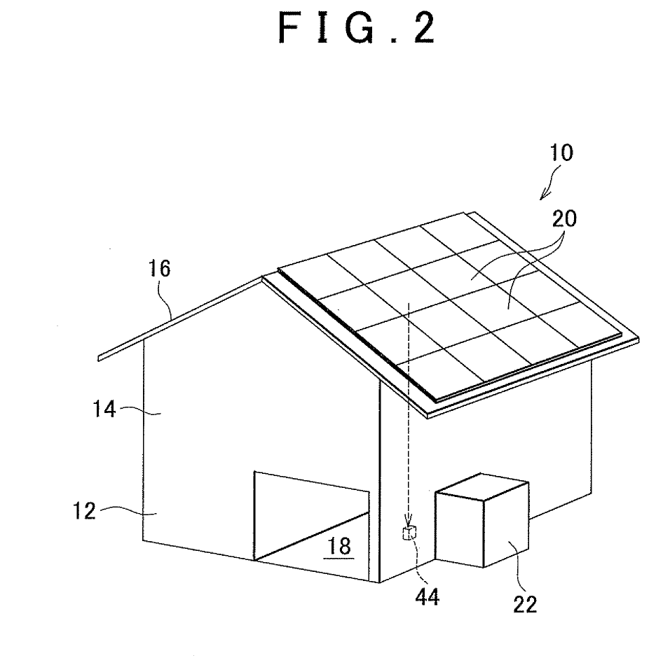

FIG. 2 is a perspective view schematically showing the house 10 according to this example embodiment. As shown in the drawing, the house 10 as a building is made up of the first floor portion 12, a second floor portion 14, and a roof portion 16. The indoor garage 18 being provided in the first floor portion 12. Also, the roof portion 16 is lined with solar panels (i.e., solar battery panels) 20 that are used to generate solar power. Moreover, a natural refrigerant heat pump water heater 22 is provided on the side of the first floor portion 12.

Here, the house 10 described above has secondary batteries 40 dispersed in sets of one or two or more individual secondary batteries in a plurality of locations inside the house 10. Using the first floor portion 12 as an example, the secondary batteries 40 are arranged in locations encircled by alternate long and short dash lines P in FIG. 1. Incidentally, the secondary batteries 40 are also arranged on the second floor portion 14 and the roof portion 16 as necessary.

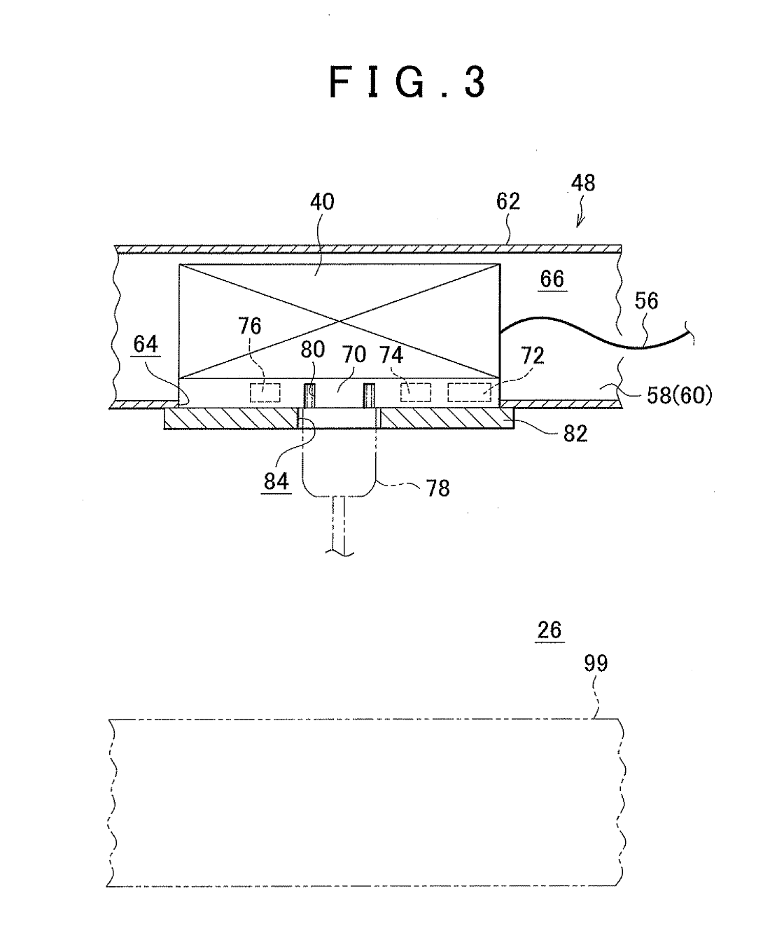

More specifically, as shown in FIG. 1, an exterior wall 42 is provided on the outer periphery of the house 10. A portion of the exterior wall 42 is also a side wall of the indoor garage 18. A plurality of the secondary batteries 40 and a main control panel 44 as a main control portion 44 that serves as a control portion (i.e., a first control portion) are arranged in the exterior wall 42. Also, two sets of secondary batteries 40 are arranged apart from each other in the exterior wall 42 on the Japanese-style room 26 side. Furthermore, a secondary battery 40 is also arranged in a partition wall 46 between the washroom 30 and the bathroom 28, as well as in a partition wall 48 between the washroom 30 and the Japanese-style room 26. A secondary battery 40 is also arranged in the exterior wall 42 on the toilet 32 side, as well as in the exterior wall 42 on one side of the entryway 24 and in a partition wall 50 on the other side of the entryway 24. Moreover, a secondary battery 40 is also arranged in a partition wall 54 between the storage space 36 and a stairway 52. Each of the secondary batteries 40 that are arranged in the various locations is connected to the main control panel by a wire 56 (see FIG. 3).

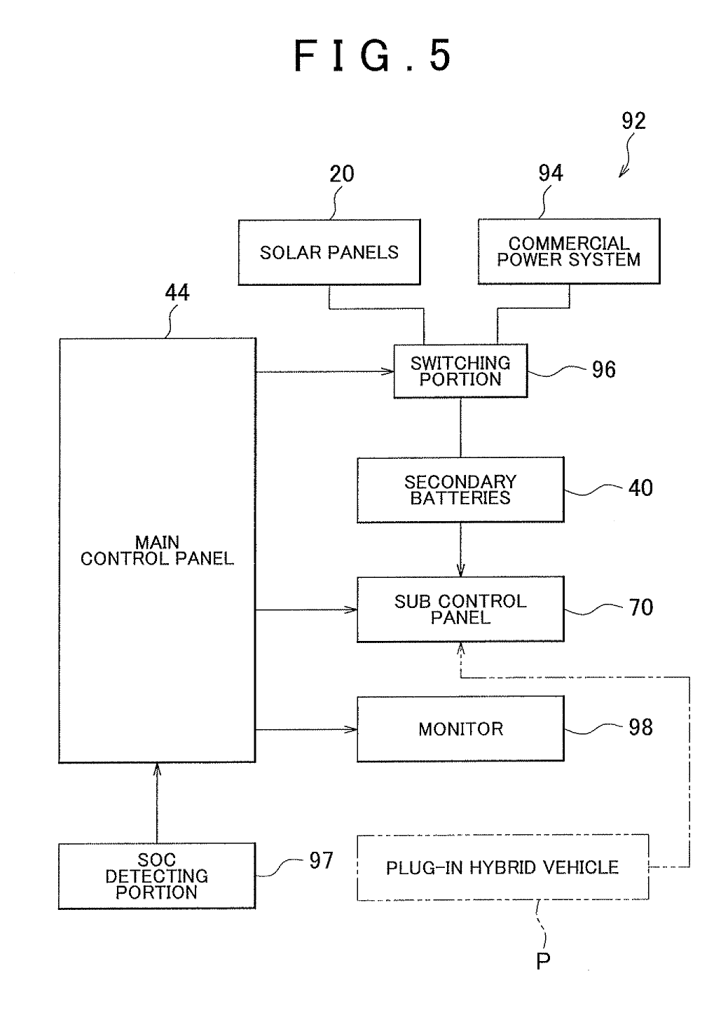

Incidentally, a switching portion 96 is connected to the main control panel 44, as shown in FIG. 5 that will be described later, and power is supplied to the secondary battery 40 so as to charge the secondary battery 40, by selectively using two systems, i.e., an external power supply system that uses the solar panels 20, and a commercial power system 94. Also, as will be described later, the power from each secondary battery 40 may be supplied to direct loads, or transferred to another secondary battery 40 via the main control panel 44. For example, excess power in a battery of a plug-in hybrid vehicle P (see FIG. 1) may be supplied to a secondary battery 40 that is connected to a cable so to charge the secondary battery 40, and then that charged power may be transferred to another secondary battery 40 via the main control panel 44.

FIG. 3 is an enlarged sectional view showing the manner in which the secondary battery 40 arranged in the partition wall 48 between the washroom 30 and the Japanese-style room 26 is housed. As shown in the drawing, the partition wall 48 has finishing material tacked to both surfaces of a base sheet 60 formed by a horizontal frame 58 and a vertical frame, not shown. A rectangular open portion 64 is formed on the upper edge side of the horizontal frame 58 in one of the finishing material 62. The space in the wall in the depth direction of this open portion 64 serves as a secondary battery housing portion 66. That is, the secondary battery housing portion 66 is provided in dead space inside the partition wall 48. The secondary battery 40 is inserted through this open portion 64, placed on the horizontal frame 58, and fixed in place with a fixing bracket or the like. However, a special case or the like for housing the secondary battery 40 may also be fixed inside the partition wall 48.

A sub control panel 70 that serves as a control portion (i.e., a second control portion) is arranged on the front surface of the secondary battery 40. This sub control panel 70 includes a capacitor 72, a switching element 74 that converts direct current into alternating current, and a switching portion 76 that switches between a power supply path for power discharged from the capacitor 72 and a power supply path for commercial power. The sub control panel 70 is connected to the secondary battery 40 (the wiring is not shown), and power stored in the secondary battery 40 is stored in the capacitor 72. Further, the sub control panel 70 is also connected to the main control panel 44. Upon receiving a discharge signal from the main control panel 44, the capacitor 72 provided in the sub control panel 70 discharges a predetermined amount of power. Moreover, this sub control panel 70 also serves as an outlet and includes a receptacle 80 for a plug 78. Incidentally, because the sub control panel 70 also serves as an outlet, it is kept fitted in the open portion 64.

Incidentally, with this structure, excess power may also be charged to the secondary battery 40 corresponding to the sub control panel 70 by connecting the power plug of the plug-in hybrid vehicle P to the receptacle 80 of the sub control panel 70.

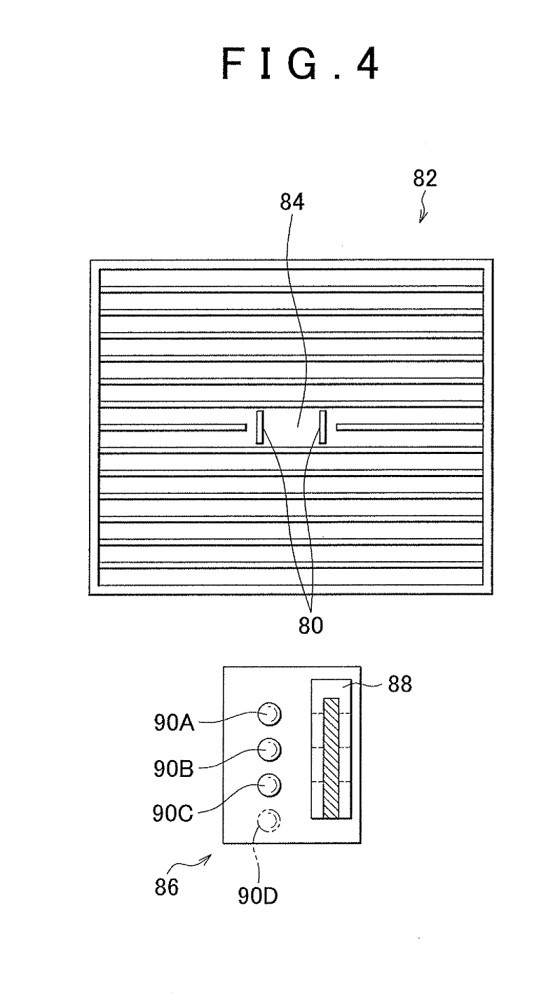

A louver 82 is arranged on the front surface of the sub control panel 70. This louver 82 serves to protect the secondary battery 40 from overheating by facilitating the dissipation of heat from the secondary battery 40 and allowing air from inside the room to flow to the secondary battery 40 side. As shown in FIGS. 3 and 4, a rectangular open portion 84 for inserting the plug 78 is formed in the center portion of the louver 82, and the receptacle 80 of the sub control panel 70 faces the open portion 84. Incidentally, in this example embodiment, the louver 82 is detachably retained at the peripheral edge portion of the open portion 64 by an elastically deformable engaging pawl or the like, but it may also be detachably mounted to the sub control panel 70. Also, a hinge may be provided on the lower or side edge of the louver 82, and the louver 82 may be mounted so as to be able to pivot around the hinge.

Also, as shown in FIG. 4, an operating panel 86 is arranged below the louver 82. This operating panel 86 has a display portion 88 that displays the state-of-charge (SOC) (i.e., the amount of stored power) of the secondary battery 40, and operating buttons 90A to 90C on it. If the operating button 90A is pushed, the switching portion 76 of the sub control panel 70 switches from the power supply path for power discharged from the capacitor 72 to the power supply path for commercial power. If the operating button 90B is pushed, the switching portion 76 switches from the power supply path for commercial power to the power supply path for power discharged from the capacitor 72. Further, if the operating button 90C is pushed, the manual operation is canceled, and the switching portion 76 returns to its initial state, which is that of the power supply path for the power discharged from the capacitor 72.

Incidentally, a switch 90D (indicated by the alternate long and two short dashes line in FIG. 4) for supplying excess power in the battery of the plug-in hybrid vehicle P or the like to the secondary battery 40 after the power plug of the plug-in hybrid vehicle P is plugged into the receptacle 80 may also be provided on the operating panel 86 arranged in the indoor garage 18.

FIG. 5 is a block view of a power storage system 92 formed by the structure described above. As shown in the drawing, the solar panels 20 and the commercial power system 94 are connected to the secondary battery 40 via the switching portion 96. The main control panel 44 is connected to the switching portion 76, and switches between the external power supply system in which power generated by the solar panels 20 is stored in the secondary battery 40 and the commercial power system in which the secondary battery 40 receives midnight power.

Also, the main control panel 44 is connected to the sub control panel 70 and a SOC detecting portion 97. The SOC detecting portion 97 is arranged in each secondary battery 40, and detects the SOC (i.e., the amount of stored power) of the secondary battery 40 and outputs a signal indicative thereof to the main control panel 44. The SOC detecting portion 97 may for example be structured to detect the amount of charge and discharge using a current sensor and obtain the SOC from the integrated value thereof, or it may have another type of structure. In the main control panel 44, the SOC of each secondary battery 40 is centrally controlled from the current SOC detected by the SOC detecting portion 97.

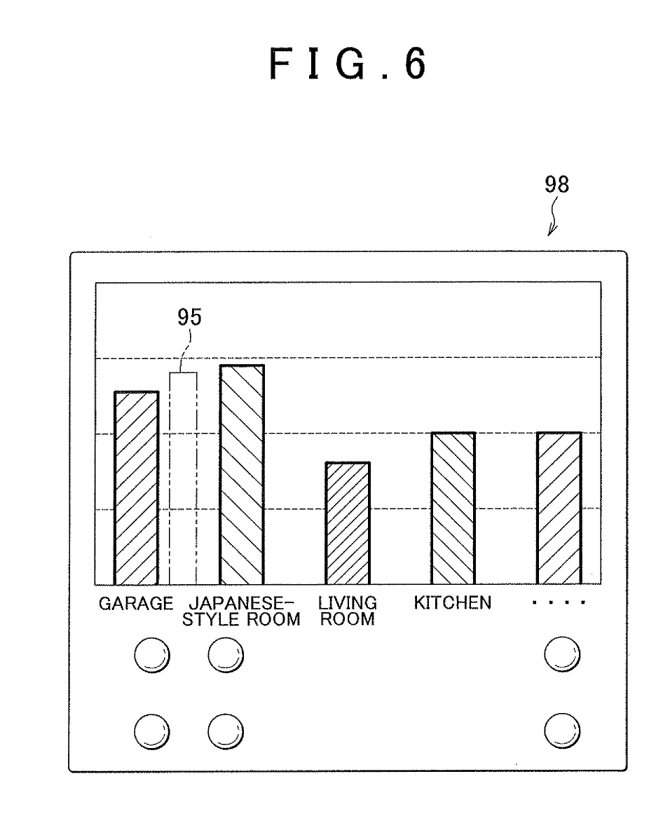

Moreover, the main control panel 44 is connected to a monitor 98. As shown in FIG. 6, the monitor 98 displays the SOC detected by the SOC detecting portion 97 on a screen (i.e., a display portion) at each location where a secondary battery 40 is arranged.

Incidentally, as described above, if excess power stored in the plug-in hybrid vehicle P is transferred, a display portion 95 that displays the amount of excess power may also be provided on the monitor 98, as indicated by the alternate long and two short dashes line in FIG. 6. However, normally, information about the SOC is obtained from the plug-in hybrid vehicle P from information communicated through a power line from the plug-in hybrid vehicle P.

Also, the order of priority when charging a secondary battery 40 arranged inside the house 10 is stored in the main control panel 44. This order of priority is determined such that, for example, priority is given in order starting with the secondary battery 40 having the largest required capacity. While this is the general rule, if the current capacity of a secondary battery 40 happens to fall below a reference value (i.e., a predetermined value), priority is given to charging that secondary battery 40. Incidentally, the order of priority when charging the secondary batteries 40 may be changed as appropriate by operating an operating panel, not shown, provided on the main control panel 44 or by performing an operation with the screen of the monitor 98.

The secondary battery 40 and the sub control panel 70 may be expanded in the future during a renovation or if the family structure changes or the like.

Also, in this example embodiment, a small lithium-ion secondary battery (i.e., a lithium battery) is used as the secondary battery 40. However, other than a lithium-ion secondary battery, a lead battery, a nickel-metal hydride secondary battery, or another battery may be used.

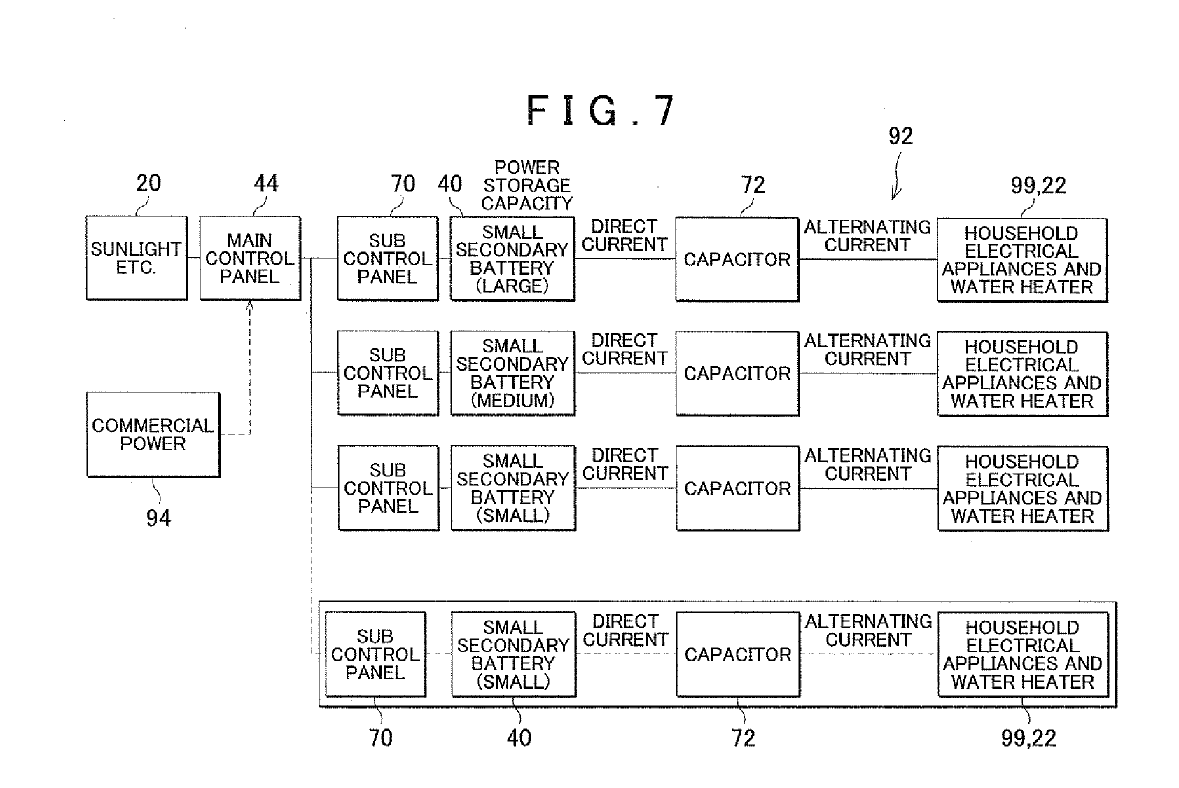

Next, the overall operation of the power storage system 92 applied to the house 10 according to the example embodiment will be described with reference to FIG. 7.

FIG. 7 is a system diagram of the power storage system 92 according to the example embodiment. As shown in this example embodiment, during the daytime, the main control panel 44 controls the switching portion 96 to switch to the external power receiving path so that charging is performed using power obtained by solar power generation. Accordingly, the secondary battery 40 is charged by the external power supply system using the solar panels 20. Also, at night, the main control panel 44 controls the switching portion 96 to switch to the commercial power receiving path in order to use midnight power. Accordingly, the secondary battery 40 is charged by the commercial power system 94 using midnight power.

The power storage capacity of the secondary battery 40 is set differently according to the size of the load at each location where the secondary batteries 40 are arranged. That is, some secondary batteries 40 have a large power storage capacity, some have a medium power storage capacity, and others have a small power storage capacity. Incidentally, secondary batteries 40 with large power storage capacities are arranged in the indoor garage 18 and the washroom 30. Also, secondary batteries 40 with small power storage capacities are arranged in the storage space 36 and the Japanese-style room 26.

There are two ways to change the power storage capacity of a secondary battery 40. One is to connect the necessary number of individual power storage bodies having the same capacity and thus increase the power storage capacity by an integral multiple, and the other is to provide a single secondary battery 40 in advance that is capable of providing the required power storage capacity. In the former case, there is no need to prepare a plurality of types of secondary batteries 40 of different power storage capacities beforehand, which eliminates the wire connecting work and thus enables costs to be reduced by that amount. In the latter case, the required power storage capacity is provided by a single secondary battery 40, so less space is required for mounting compared with when the capacity is increased by connecting a plurality of individual secondary batteries 40 together. The selection between these two methods is determined taking the cost as well as the size of the available secondary battery housing portions 66 and the like into account.

The power stored in the secondary battery 40 is stored in the capacitor 72 of the sub control panel 70. When a plug 78 (see FIG. 3) of the natural refrigerant heat pump water heater 22 (see FIG. 2) or a household electrical appliance is plugged into the receptacle 80 of the sub control panel 70 that also serves as an outlet, the switching element 74 switches to alternating current of a predetermined frequency and power is supplied.

When controlling the power storage state of the individual secondary batteries 40 with the main control panel 44, the order of priority when charging a secondary battery 40 is determined in advance, as described above, and power is stored starting with the secondary battery 40 that is highest in the order of priority. That is, when charging during the daytime, the main control panel 44 controls the switching portion 96 to select the external power receiving path. However, power obtained by solar power generation is affected by the number and performance of the solar panels 20 arranged on the house 10, and is therefore generally limited. The power able to be obtained by solar power generation is also affected by the weather. Thus, to efficiently and effectively charge the secondary batteries 40, it is appropriate that charging be in order from the secondary battery 40 that is highest in the order of priority. Therefore, for example, the order of “the secondary battery 40 arranged in the indoor garage 18→the secondary battery 40 arranged in the washroom 30→the secondary battery 40 arranged in the bathroom 28→the secondary battery 40 arranged in the toilet 32→the secondary battery 40 arranged in the Japanese-style room 26→the secondary battery 40 arranged in the entryway 24→the secondary battery 40 arranged in the storage space 36” is determined in advance and power is stored in that order. Also, if the power from solar power generation is insufficient, the main control panel 44 controls the switching portion 96 to switch to the commercial power receiving path such that power is received from the commercial power system 94.

Moreover, the SOC of each secondary battery 40 can be checked with the display portion 88 of the operating panel 86 arranged below the louver 82, so if a household electrical appliance 99 that consumes an enormous amount of power is used, the power supply can be switched manually. More specifically, if the operating button 90A is pushed, the switching portion 76 will switch to the indoor wire side that transmits commercial power and alternating current will be supplied. Accordingly, a user is able to avoid a decrease in performance in a secondary battery 40 due to drastic power use.

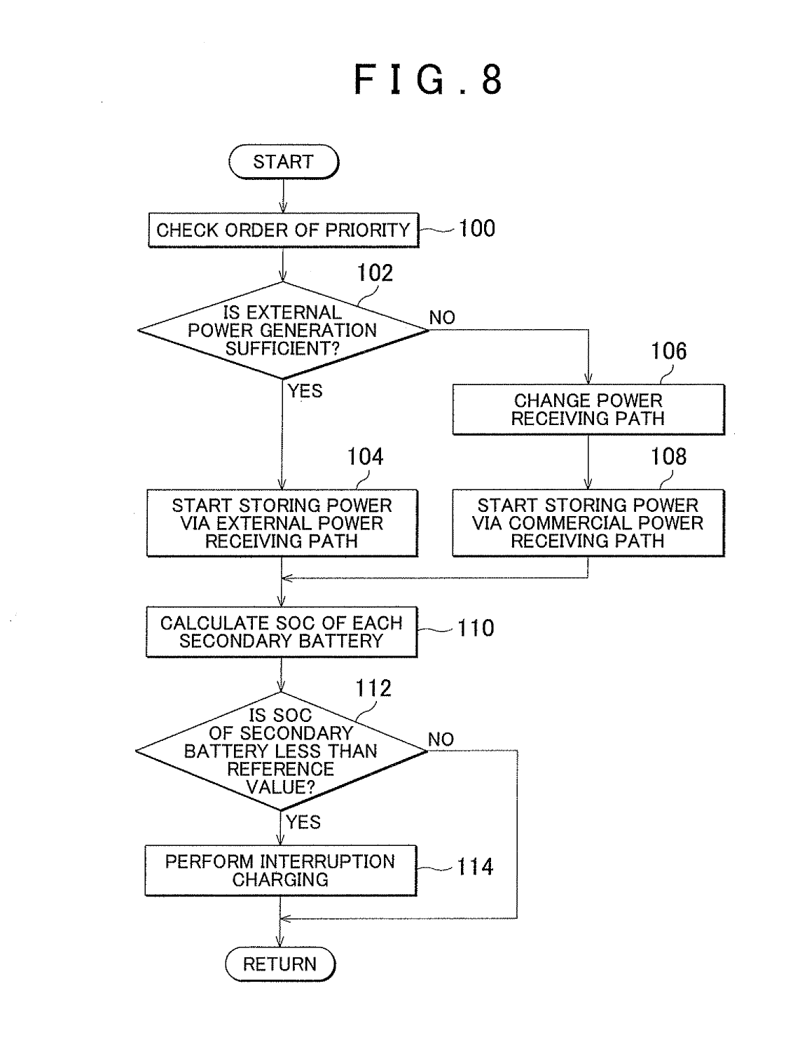

Next, control during charging will be described with reference to the flowchart shown in FIG. 8. This control is performed by a control portion, not shown, that forms a part of the main control panel 44.

First, in step 100, the order of priority is checked. Incidentally, in the initial state, the order of priority illustrated in the previous example is determined. However, if the order of priority is changed by a direct operation or an indirect (i.e., remote) operation of the main control panel 44 or the monitor 98, that order of priority is updated.

Continuing on, in step 102, it is determined whether external power generation is sufficient. This external power generation refers to solar power generation using the solar panels 20. If the weather is clear and there is sufficient sunlight, it is determined that power generation of equal to or greater than a predetermined value that is set in advance is able to be obtained, so the determination is yes. If the determination in step 102 is yes, the process proceeds on to step 104 where power starts to be stored in the secondary battery 40 via the external power receiving path. That is, the switching portion 96 selects the external power receiving path.

If, on the other hand, sufficient power generation is not possible due to rainy weather, for example, it determination in step 102 is no and the process proceeds on to step 106 where the switching portion 96 is switched so that the path changes from the external power receiving path to the commercial power receiving path. Then the process proceeds on to step 108 where power starts to be stored in the secondary battery 40 via the commercial power receiving path.

Next, the process proceeds on to step 110 where the SOC of each secondary battery 40 is calculated. Then the process proceeds on to step 112 where it is determined whether the SOC according to the calculation results is less than a reference value. If the determination in step 112 is yes, then the process proceeds on to step 114 where interruption charging is performed. That is, the secondary battery 40 having a SOC that is less than the reference value is forcibly charged quickly regardless of the order of priority. As a result, it is possible to prevent the secondary battery 40 from dying (i.e., becoming totally drained). Once interruption charging is executed in step 114, the process returns to step 100.

If, on the other hand, the determination in step 112 is no, it means that all of the secondary batteries 40 have a SOC that is equal to or greater than the reference value, so the process returns to step 100.

Incidentally, the control during charging described above is only an example and may be modified appropriately as necessary. For example, the SOC reference value of the secondary battery 40 may be specified as 30% of full charge uniformly for all of the secondary batteries 40, or it may be weighted according to the order of priority. For example, a SOC reference value with a safety factor that is 1.5 times that SOC reference value (i.e., 45%) may be specified for a secondary battery 40 at a location where a large SOC is required, such as in the washroom 30, while a SOC reference value with a safety factor of 1.0 times that SOC reference value (i.e., 30%, i.e., unchanged) may be specified for a secondary battery 40 where a small SOC is sufficient, such as in the Japanese-style room 26.

In this example embodiment, the secondary battery housing portions 66 and the secondary batteries 40 are dispersed in a plurality of locations inside the house 10, so if power is needed, it can be supplied from the secondary battery 40 nearest the location where it is needed. Therefore, it is easier to draw power stored in the secondary batteries 40 than it is when a secondary battery housing portion and a secondary battery are arrange only in one location in a house. As a result, this example embodiment enables power corresponding to a load to be easily drawn from various locations inside.

Also, in this example embodiment, power can be stored in the secondary batteries 40 selectively from either the external power supply system that uses solar power generation or the commercial power system using midnight power. As a result, power can be stored in the secondary battery 40 using both midnight power which is inexpensive and power generated by solar power generation during the daytime. Therefore, according to this example embodiment, the secondary battery 40 can be charged inexpensively.

Furthermore, with this example embodiment, the SOCs of the secondary batteries 40 dispersed in the various locations are displayed all together on the monitor 98, which enables the SOC of each secondary battery 40 to be checked instantaneously by looking at the display on the monitor 98. Accordingly, this example embodiment makes it possible to easily monitor the SOC of each secondary battery 40.

Also, in this example embodiment, the order of priority when charging the secondary batteries 40 is determined in advance and charging is performed in order from the secondary battery 40 that is highest in the order of priority by the main control panel 44. Therefore, when the amount of power generated by solar power generation is small, for example, charging is performed starting with the secondary battery 40 that is highest in the order of priority. Accordingly, it is possible to prevent a situation in which the SOC of the secondary battery 40 in the indoor garage 18 or the washroom 30 where the level of importance is relatively high becomes insufficient unnoticed. Therefore, this example embodiment makes it possible to control the power supplied from the secondary batteries 40 according to the level of importance.

Moreover, in this example embodiment, when the SOC of a secondary battery 40 becomes less than the reference value, the highest priority is given to charging that secondary battery 40, regardless of the order of priority, so the SOC will not become zero even if the secondary battery 40 is lowest in the order of priority. As a result, this example embodiment makes it possible to stably maintain the power storage state in a secondary battery network made up of dispersed secondary batteries 40.

Also, in this example embodiment, the load used in each location where the secondary battery 40 is arranged differs and the required power is also different, so the SOC of each secondary battery 40 is set according to the corresponding required power. Therefore the SOCs of the secondary batteries 40 will never be insufficient for the loads used in the locations where the secondary batteries are arranged. Accordingly, this example embodiment makes it possible to supply the required power to each location where the secondary batteries are arranged.

In this example embodiment, the secondary battery 40 is formed of a single or plurality of individual secondary batteries. If the secondary battery 40 is realized by a single secondary battery 40, a secondary battery 40 having a capacity of equal to or greater than the power required in each location where the secondary batteries 40 are arranged may be used. If, on the other hand, the secondary battery 40 is realized by a plurality of individual secondary batteries, secondary batteries having the same capacity may be connected together, such that a capacity of equal to or greater than the power required at each location where the secondary batteries 40 are arranged is obtained, and used, or secondary batteries having a plurality of various capacities may be combined and used. The determination as to whether to form the secondary battery 40 with a single secondary battery or a plurality of secondary batteries connected together may be made according to, for example, the specifications of the secondary battery and the size of the secondary battery housing portion and the like. Therefore, according to this example embodiment, a system can be configured taking into account the specifications of the secondary battery and the size of the secondary battery housing portion and the like, so it can be applied to various house designs.

Also, in this example embodiment, one of the secondary batteries 40 is arranged in the indoor garage 18, so a vehicle that requires charging, such as a plug-in hybrid vehicle P, can be directly charged from the indoor garage 18. Accordingly, with this example embodiment, the secondary batteries 18 are dispersed, including in the indoor garage 18 as well, so power according to a load can be easily and quickly supplied from the indoor garage 18 as well. Furthermore, arranging a secondary battery 40 in the indoor garage 18 so that the plug-in hybrid vehicle P can be charged by the secondary battery 40 also makes it possible to transfer excess power from the plug-in hybrid vehicle P to another secondary battery 40 as described above.

Also, in this example embodiment, the sub control panel 70 that functions as an outlet is provided in the secondary battery housing portion 66, so a household electrical appliance or a natural refrigerant heat pump water heater can be directly connected to the receptacle 80 of the sub control panel 70. Accordingly, the additional wiring that is required when the sub control panel 70 is provided in a different location than the secondary battery housing portion 66 is not necessary. As a result, the degree of freedom is increased by that amount. Also, the work of arranging the wiring is no longer necessary so the work at the building site can be reduced. As a result, this example embodiment makes it possible to shorten the construction time because the degree of freedom in design can be increased and the work at the building site can be reduced.

In the example embodiment described above, the secondary batteries 40 are dispersed in a plurality of locations inside the house 10, but the invention is not limited to this. That is, the secondary batteries may also be dispersed in a plurality of locations both inside and outside the house 10. For example, in this example embodiment, the indoor garage 18 is provided in the first floor portion 12 of the building 10. However, one or a plurality of secondary batteries may also be arranged in the garage when the garage is provided outside (i.e., separate from) the house.

Also, in the example embodiment described above, the invention is applied to the house 10, but the invention is not limited to this. That is, the invention may also be applied to a building other than a house, such as a unit building or the like.

Moreover, in the example embodiment described above, the solar panels 20 are mainly described as an example as the external power supply system. However, the external power supply system also includes excess power from a vehicle such as the plug-in hybrid vehicle, an electric vehicle, and a fuel cell vehicle, as appropriately described. The excess power of this vehicle can be transferred to a secondary battery (including a replacement battery in the building that will be used to replace the battery in the electric vehicle) arranged in the building by parking the vehicle in the garage, so the battery of the vehicle can also be used as an external power supply.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. A building comprising:
a plurality of secondary battery housing portions provided dispersed in a plurality of locations inside or inside and outside; and
a plurality of secondary batteries, wherein each of the secondary battery is housed in a corresponding secondary battery housing portions.

2. The building according to claim 1, wherein each of the plurality of secondary batteries is selectively charged from one of an external electric power supply system or a commercial power system.

3. The building according to claim 2, wherein each of the plurality of secondary batteries includes an operating portion, and the operating portion selects one of the external power supply system and the commercial power system.

4. The building according to claim 1, wherein a state-of-charge of each of the plurality of secondary batteries is displayed on at least one monitor.

5. The building according to claim 1, further comprising:
a control portion that controls charging of the plurality of secondary batteries,
wherein a predetermined order of priority in charging the plurality of secondary batteries is stored in the control portion, and
wherein the control portion instructs the plurality of secondary batteries to be charged in the predetermined order of priority.

6. The building according to claim 5, wherein if a state-of-charge of one of the secondary batteries becomes less than a reference value, the control portion gives the highest priority to charging the secondary battery having the state-of-charge that is less than the reference value, regardless of the predetermined order of priority.

7. The building according to claim 5, wherein the predetermined order of priority may be changed by a user.

8. The building according to claim 1, wherein the secondary battery arranged at each of the plurality of locations has a power storage capacity based on power required at each of the plurality of locations.

9. The building according to claim 8, wherein each of the plurality of secondary batteries is formed by one or a plurality of power storage bodies.

10. The building according to claim 1, wherein a portion of the secondary batteries is arranged in a garage.

11. The building according to claim 10, wherein the secondary battery arranged in the garage is connected to a vehicle secondary battery.

12. The building according to claim 11, wherein:
if it is determined that there is excess power in the vehicle secondary battery, power is supplied from the vehicle secondary battery to the secondary battery arranged in the garage; and
the power is supplied from the secondary battery arranged in the garage to at least one of the secondary batteries arranged in the plurality of locations.

13. The building according to claim 1, wherein a connecting portion into which a household electrical appliance or a natural refrigerant heat pump water heater is directly connected and which supplies power stored in the secondary battery by being connected thereto, is provided in each of the secondary battery housing portions.

14. A power storing method of a plurality of secondary batteries arranged in a building, comprising:
checking a predetermined order of priority when charging the plurality of secondary batteries; and
charging starting with the secondary battery that is highest in the order of priority.

15. The power storing method according to claim 14, wherein if a state-of-charge of one of the secondary batteries is less than a reference value, the highest priority is given to charging the secondary battery having the state-of-charge that is less than the reference value, regardless of the order of priority.
